(19) United States
(12) Patent Application Publication
(10) Pub. No.: US 2016/0195460 A1
(43) Pub. Date: Jul. 7, 2016

(54) MEASURING MECHANICAL PROPERTIES OF A SPECIMEN

(71) Applicant: GENERAL MILLS, INC., Minneapolis, MN (US)

(72) Inventors: Ralph A. Stenvik, Plymouth, MN (US); Randy Rue, Ham Lake, MN (US); Mark Stueber, Henderson, MN (US)

(21) Appl. No.: 14/911,423

(22) PCT Filed: Aug. 15, 2013
(86) PCT No.: PCT/US13/55088

§ 371 Date: Feb. 10, 2016

(51) Int. Cl. G01N 3/20

(52) U.S. Cl. CPC G01N 3/20

(57) ABSTRACT

An apparatus for measuring mechanical properties of a specimen is disclosed. The apparatus includes a base and a cradle. The cradle includes a cradle frame attached to the base via a mounting element, and first and second cradle arms each rotatably attached to the cradle frame. Each of the first and second cradle arms includes a specimen receiving portion that is configured to hold a specimen in place. The first cradle arm is rotatable about a first axis and the second cradle arm is rotatable about a second axis that is substantially parallel to the first axis. The apparatus further includes an actuator configured to provide a force F to a central portion of the specimen in a direction substantially orthogonal to the first and second axes and the base, and a load cell positioned between the cradle frame and the base. The load cell is configured to measure F.

### PRIORITY CLAIM AND CROSS-REFERENCE TO RELATED APPLICATIONS

The present application is a National Stage of International Application No. PCT/US2013/055088, filed on Aug. 15, 2013, the entire contents of which are incorporated herein by reference.

### BACKGROUND

Various processes that operate on or convert certain specimens such as agricultural products require that the specimens exhibit various mechanical properties to withstand the rigors of these processes. These mechanical properties are specific to the particular type of specimen and the desired processing required for the specimen. For example, various processes are designed to remove kernels from an ear of corn. During these processes, the ear of corn can be subjected to various forces. Ears of corn that cannot withstand these forces can slow down production and lower yields, thereby increasing production costs. Measuring the mechanical properties of specimens such as corn and selecting specific crops or lots of specimens that meet the particular mechanical requirements prior to processing the specimens can decrease costs and increase yields.

### SUMMARY

In general, the present disclosure describes various embodiments of an apparatus for measuring various mechanical properties of a specimen and systems that utilize these apparatuses.

In one aspect, the present disclosure provides an apparatus that includes a base and a cradle. The cradle includes a cradle frame attached to the base via a mounting element; and first and second cradle arms each rotatably attached to the cradle frame. Each of the first and second cradle arms includes a specimen receiving portion that is configured to hold a specimen in place. The first cradle arm is rotatable about a first axis and the second cradle arm is rotatable about a second axis that is substantially parallel to the first axis. The apparatus further includes an actuator configured to provide a force F to a central portion of the specimen in a direction substantially orthogonal to the first and second axes and the base, and a load cell positioned between the cradle frame and the base. The load cell is configured to measure F.

In another aspect, the present disclosure provides a method that includes placing a specimen in an apparatus. The apparatus includes a base and a cradle. The cradle includes a cradle frame attached to the base via a mounting element, and first and second cradle arms each rotatably attached to the cradle frame. Each of the first and second cradle arms includes a specimen receiving portion that is configured to hold a specimen in place. The first cradle arm is rotatable about a first axis and the second cradle arm is rotatable about a second axis that is substantially parallel to the first axis. The apparatus further includes an actuator configured to provide a force F to a central portion of the specimen in a direction substantially orthogonal to the first and second axes and the base, and a load cell positioned between the cradle frame and the base. The load cell is configured to measure F. The method further includes applying force F to a central portion of the specimen in a direction substantially orthogonal to the first and second axes and the base, thereby causing the first and second cradle arms to rotate about the first and second axes respectively in a direction away from the cradle frame; and measuring a flexural strength value of the specimen.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1A is a schematic perspective view of one embodiment of an apparatus.

FIG. 1B is a schematic side plan view of the apparatus of FIG. 1A.

FIG. 1C is a schematic top plan view of the apparatus of FIG. 1A.

FIG. 1D is a schematic front plan view of the testing apparatus of FIG. 1A.

FIG. 1E is a schematic front plan view of the apparatus of FIG. 1A as a specimen has yielded to a force applied by an actuator of the testing apparatus.

FIG. 2 is a schematic diagram of one embodiment of a system that includes a testing apparatus and a controller coupled to the testing apparatus.

### DETAILED DESCRIPTION

In general, the present disclosure describes various embodiments of an apparatus for measuring various mechanical properties of a specimen and systems that utilize such apparatuses. In some embodiments, the apparatus includes a base and a cradle. The cradle can include a cradle frame attached to the base via a mounting element, and first and second cradle arms each rotatably attached to the cradle frame. In some embodiments, each of the first and second cradle arms includes a specimen receiving portion that is configured to hold a specimen in place. In some embodiments, the first cradle arm is rotatable about a first axis and the second cradle arm is rotatable about a second axis that is substantially parallel to the first axis. The apparatus also includes an actuator configured to provide a force F to a central portion of the specimen in a direction orthogonal to the first and second axes and the base; and a load cell positioned between the cradle frame and the base, where the load cell is configured to measure F applied to the specimen by the actuator.

In some embodiments, the apparatus can measure various mechanical properties of a specimen to assist in determining whether the specimen is suitable for subsequent processing. For example, in some embodiments, an ear of corn can be tested using various embodiments of the described apparatus and system to determine whether the corn is suitable for use in a process or processes that remove kernels from the ear. The described apparatuses and systems can be utilized in a laboratory or in the field.

Applicants have found that the rotating cradle arms can aid in more accurately determining whether a particular specimen is suitable for further processing. While not wishing to be bound by any particular theory, the rotating cradle arms uniquely simulate the types of forces that will be applied to a specimen during these subsequent processing steps. Further, the rotating cradle arms can better accommodate samples of varying shapes and sizes.

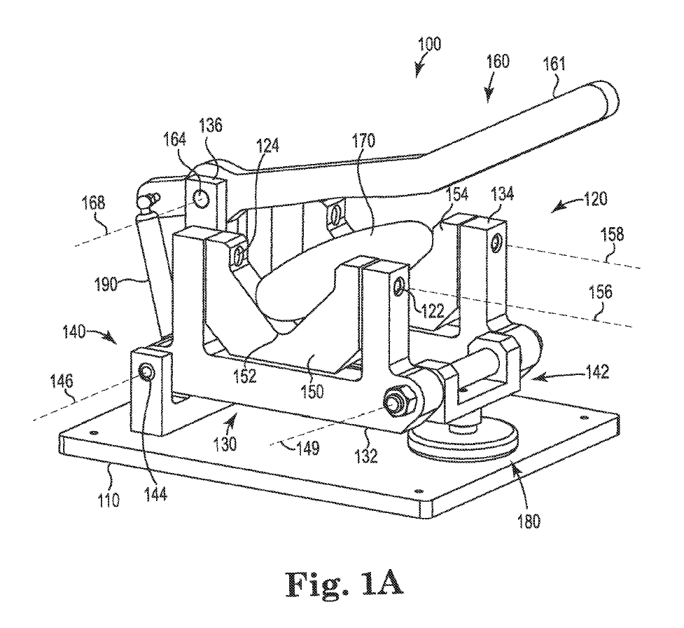

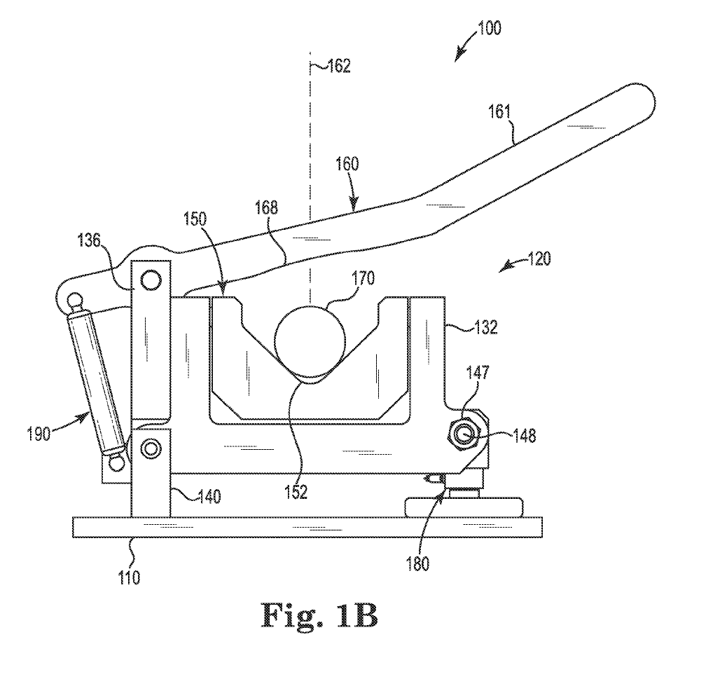

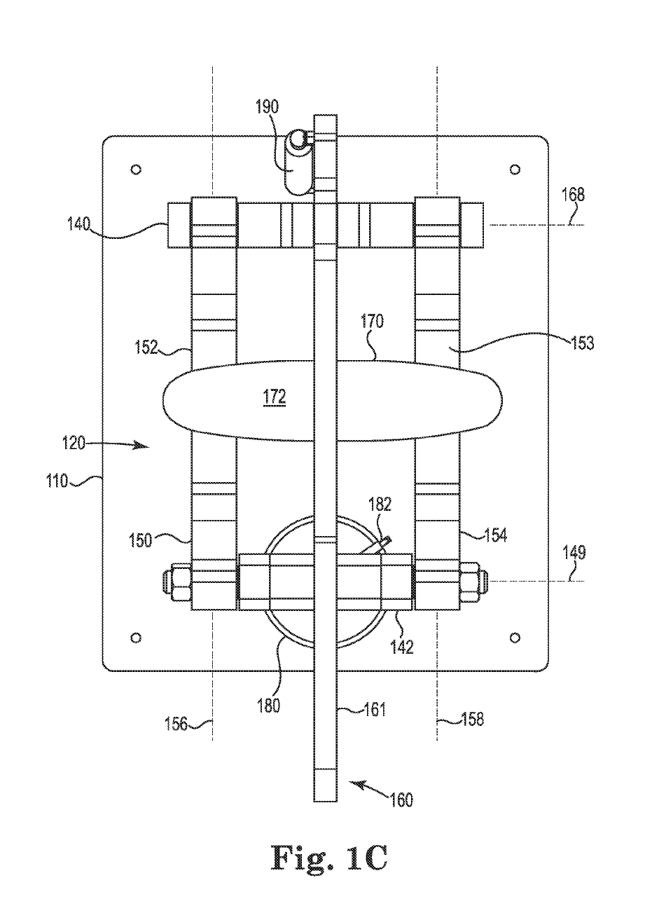

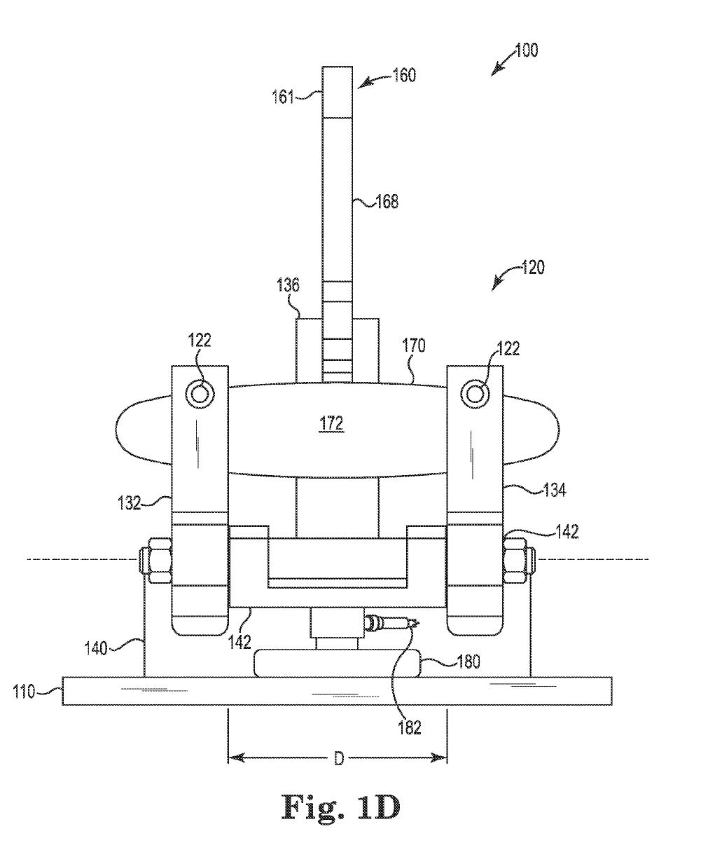

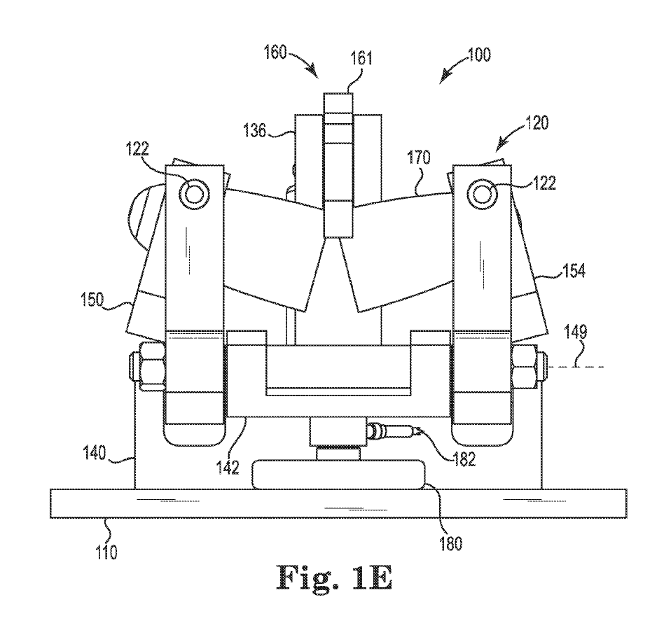

FIGS. 1A-E are various schematic views of one embodiment of an apparatus 100. The apparatus 100 includes a base 110 and a cradle 120. The cradle 120 includes a cradle frame 130 attached to the base 110 via a mounting element 140, and first and second cradle arms 150, 154 each rotatably attached to the cradle frame. In some embodiments, the first and second cradle arms 150, 154 are each attached to the cradle frame 130 at first and second pivot points 122, 124.

The first and second cradle arms 150, 154 include a specimen receiving portion 152, 153 that are configured to hold a specimen 170 in place. The first cradle arm 150 is rotatable about a first axis 156, and the second cradle arm 154 is rotatable about a second axis 158 that is substantially parallel to the first axis.

The apparatus 100 also includes an actuator 160 that is configured to provide a force F to a central portion 172 of the specimen 170 in a direction 162 orthogonal to the first and second axes 156, 158 and the base 110. The apparatus 100 also includes a load cell 180 positioned between the cradle frame 130 and the base 110, where the load cell is configured to measure F.

The cradle frame 130 can take any suitable shape. In some embodiments, the cradle frame 130 can include first and second u-shaped portions 132, 134 that are attached to the mounting element 140 and the load cell 180 using any suitable technique.

In some embodiments, the cradle frame 130 is configured such that a distance D between the first and second u-shaped portions 132, 134 can be adjusted. For example, in some embodiments, the u-shaped portions 132, 134 are slidably attached to the cradle frame 130 such that the distance D between the first and second u-shaped portions can be adjusted. In such embodiments, the apparatus 100 can also include any suitable locking mechanism for fixing the first and second u-shaped portions 132, 134 in place once a desired distance D between the portions has been set.

As illustrated in FIGS. 1A-E, the cradle frame 130 is attached to the mounting element 140 at pivot points 144 such that the cradle frame is pivotably attached to the base 110 via the mounting element. In some embodiments, the cradle frame 130 is rotatable about a fourth axis 146 that is substantially parallel to the base 110 and substantially orthogonal to the first and second axes 156, 158. In other embodiments, the cradle frame 130 is attached to the base 110 via mounting element 140 such that it is not rotatable about an axis.

In some embodiments, the cradle frame 130 is attached to the load cell 180 via a mounting element 142. As illustrated, the mounting element 142 includes bolt 148 secured to the cradle frame 130 with nuts 147; however, any suitable connecting mechanism can be utilized to attach the frame 130 to the load cell 180. In some embodiments, the cradle frame 130 is attached to the load cell 180 such that it is free to rotate about a fifth axis 149 that is substantially parallel to the forth axis 146.

The cradle frame 130 can include any suitable material or materials that provide sufficient rigidity, e.g., steel, aluminum, carbon fiber, polymeric, etc. In some embodiments, the cradle frame 130, mounting elements 140, 142 and the base 110 can be made of the same materials; in other embodiments, the cradle frame 130, mounting element 140, 142 and base 110 can be made of different materials.

In some embodiments, the cradle frame 130 is shaped to receive the first and second cradle arms 150, 154, such that they are free to rotate about first and second axes 156, 158. For example, in the illustrated embodiment, the u-shaped portions 132, 134 are shaped such that the first and second cradle arms 150, 154 fit within the u-shaped portions.

The cradle 120 also includes first and second cradle arms 150, 154 each rotatably attached to the cradle frame 130. The first and second cradle arms 150, 154 can take any suitable shape. In some embodiments, the first and second cradle arms 150, 154 are substantially the same shape. In other embodiments, the first and second cradle arms 150, 154 can be shaped differently.

The first and second cradle arms 150, 154 can include any suitable material or materials, e.g., the same materials used for the cradle frame 130. In other embodiments, the cradle arms 150, 154 can include materials different from those of the cradle frame 130.

In some embodiments, the first and second cradle arms 150, 154 can include specimen receiving portions 152, 153 that are configured to hold a specimen 170 in place. The specimen receiving portions 152, 153 can take any suitable shape, e.g., curved, rectilinear, etc. Further, in some embodiments, surfaces of the specimen receiving portions 152, 153 that engage the specimen 170 can include any suitable texture or protuberances to hold the specimen in place as the actuator 160 engages the specimen.

As mentioned herein, the first and second cradle arms 150, 154 are rotatably attached to the cradle frame 130. In the illustrated embodiment, the first and second cradle arms 150, 154 are attached to the cradle frame 130 at pivot points 122, 124.

In some embodiments, the first cradle arm 150 is rotatable about the first axis 156, and the second cradle arm 154 is rotatable about the second axis 158 In some embodiments, the first and second cradle arms 150, 154 are rotatable in a direction away from the cradle frame 130. In other words, in some embodiments, the first and second cradle arms 150, 154 are rotatable such that the first and second specimen receiving portions 152, 153 move away from each other. In other embodiments, the first and second cradle arms 150, 154 are rotatable in a direction toward the actuator 160. In other words, the first and second cradle arms 150, 154 are rotatable such that the first and second specimen receiving portions 152, 153 move toward each other. In other embodiments, the first and second cradle arms 156, 158 are rotatable about the first and second axes 156, 158 in directions both away the cradle frame 130 and toward the actuator 160.

For example, FIG. 1E is a schematic front plan view of the apparatus 100 that illustrates the first and second cradle arms 150, 154 as rotating in a direction away from the cradle frame 130 as a force F is applied to the specimen 170 by the actuator 160. As shown, the specimen 170 has yielded, in this case breaking because of the force F being applied to its central portion 172.

Although not shown, in some embodiments, the cradle frame 130 can include any suitable locking mechanism to prevent the first and second cradle arms 150, 154 from rotating. For example, the apparatus 100 can include first and second locking mechanisms, where the first locking mechanism is configured to fix the first cradle arm 150 in place such that it cannot rotate about the first axis 156, and the second locking mechanism is configured to fix the second cradle arm 154 in place such that it cannot rotate about the second axis 158.

The apparatus 100 can also include an actuator 160 that is configured to provide the force F to the central portion of the specimen 170. The actuator 160 can include any suitable device or devices for applying force F. In the embodiment illustrated in FIGS. 1A-E, the actuator 160 includes a lever 161 that is attached to the mounting element 140 via an arm 136 of the cradle frame 130. The arm 136 extends in a direction away from the base 110. In some embodiments, the lever 161 is rotatably attached to the arm 136 at a lever pivot point 164. The actuator 160 is rotatable about a third axis 168 that is substantially orthogonal to the first and second axes 156, 158, and thus rotatably moves between the two cradle arms 150, 154 in a space between the two arms. In other embodiments, the actuator 160 can move in a non-rotational direction in the space between the two cradle arms 150, 154.

Positioned between the cradle frame 130 and the base 110 is a load cell 180. As can be seen in FIG. 1D, the load cell 180 includes a coupler 182 that is configured to couple the cell to a display and/or controller as is further described herein. The load cell 180 is configured to measure F applied to the specimen 170 by the actuator 160. The load cell 180 can include any suitable device or devices for measuring F. In some embodiments, the load cell 180 can also include a display or similar device that can provide a readout of the measured force F.

The load cell 180 can be used to determine various mechanical properties of the specimen 170. For example, the load cell 180 can be used to measure a flexural strength value of the specimen 170. As used herein, flexural strength value refers to the maximum force that a specimen will withstand before it breaks or yields. Yield refers to when a specimen is pushed past its recoverable deformation and it will no longer go back to the shape it once was, e.g., when a specimen breaks. To determine this value, the load cell 180 can be used to measure a maximum force FM applied to the specimen 170 at which the specimen yields. Other suitable mechanical properties can also be determined using apparatus 100. For example, in some embodiments, the apparatus 100 can be utilized to determine the flexural modulus of a specimen.

In some embodiments, the apparatus 100 can include a limiter 190 attached to the cradle frame 130 and an end portion of the actuator 160 or lever 161. The limiter 190 can prevent unwanted acceleration of the actuator 160 such that the force F is applied to the central portion 172 of the specimen 170 at any desired rate. The limiter 190 can include any suitable device or devices for assisting the actuator 160 in applying force F to the specimen 170 at a desired rate.

The apparatus 100 can be utilized to test the mechanical properties of any suitable specimen, e.g., ears of corn, granola bars, wood, metal, polymeric material, etc.

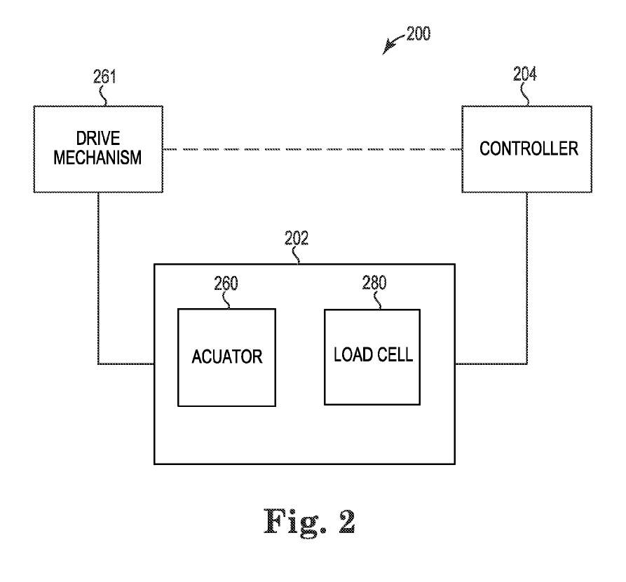

Further, the apparatuses of the present disclosure can be utilized with any suitable system. For example, FIG. 2 is one embodiment of a system 200 that includes an apparatus 202 for measuring mechanical properties of a specimen, a controller 204 coupled to the apparatus, and a drive mechanism 261 coupled to the apparatus. The apparatus 202, which in the illustrated embodiment includes an actuator 260 and a load cell 280, can be any suitable apparatus described herein, e.g., apparatus 100 of FIGS. 1A-E.

The controller 204, which can include any suitable controller, is coupled to the apparatus 202. In some embodiments, the controller 204 is coupled to the load cell 280. In some embodiments, the controller 204 is configured to determine a flexural strength value, e.g., the maximum force F_{M} at which a specimen breaks or yields. In some embodiments, the controller 204 can also determine other flexural strength values based on the force F applied to the specimen.

In some embodiments, the controller 204 can also be coupled to the drive mechanism 261. The drive mechanism 261 can in turn be coupled to the actuator 260 that is operable to apply a force F to a specimen. In such embodiments, the controller 204 is operable to control the drive mechanism 261 to provide the desired force F at a desired rate.

In reference to the apparatus 100 of FIGS. 1A-E, any suitable technique can be used with the disclosed apparatus and systems. In one exemplary embodiment, a specimen 170 is placed in the apparatus 100. In some embodiments, the specimen 170 is placed in receiving portions 152, 153 of the first and second cradle arms 150, 154. A force F is applied to the central portion 172 of the specimen 170 in the direction 162 substantially orthogonal to the first and second axes 156, 158 and the base 110. In some embodiments, the force is applied by the actuator 160, which, in the embodiment illustrated in FIGS. 1A-E, is a lever 161.

In some embodiments, as this force is applied by the actuator 160, one or both of the first and second cradle arms 150, 154 may rotate in a direction away from the cradle frame 130, i.e., in a direction away from a space interior to the cradle frame (as shown in FIG. 1E). This rotation by one or both of the cradle arms 150, 154 can, in some embodiments, be caused by the distribution of force F from the actuator 160 through the specimen to the contact points of the specimen with the specimen receiving portions 152, 153 of the cradle arms.

The force F being provided to the specimen 170 is further distributed through the cradle arms 150, 154 to the cradle frame 130 and to the load cell 180. The load cell 180 in turn is operable to measure this force F being applied to the specimen 170. The measurement of this force by the load cell 180 can be used to measure a flexural strength value of the specimen.

Applicants have found that the rotating cradle arms provide measurements of F that differ from those when the cradle arms are not allowed to rotate. For example, maple dowels having a diameter of 5/16 of an inch exhibited a maximum force FM in a range of 30-33 lbs when the cradle arms were locked, and a range of 23-24 lbs when the cradle arms were allowed to rotate.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

The invention is claimed as follows:

1. An apparatus, comprising:
a base;
a cradle, the cradle comprising:
a cradle frame attached to the base via a mounting element; and
first and second cradle arms each rotatably attached to the cradle frame,
wherein each of the first and second cradle arms comprises a specimen receiving portion that is configured to hold a specimen in place, and wherein the first cradle arm is rotatable about a first axis and the second cradle arm is rotatable about a second axis that is substantially parallel to the first axis;
an actuator configured to provide a force F to a central portion of the specimen in a direction substantially orthogonal to the first and second axes and the base; and
a load cell positioned between the cradle frame and the base, wherein the load cell is configured to measure F.

2. The apparatus of claim 1, wherein the actuator comprises a lever rotatably attached to the cradle frame, wherein the lever is rotatable about a third axis that is substantially orthogonal to the first and second axes, and further wherein the lever rotatably moves between the first and second cradle arms in a space between the two arms.

3. The apparatus of claim 2, further comprising a limiter attached to the cradle frame and an end portion of the lever.

4. The apparatus of claim 2, wherein the cradle frame further comprises an arm that is attached to the mounting element and extends in a direction away from base, wherein the lever is rotatably attached to the arm at a lever pivot point.

5. The apparatus of claim 1, wherein the cradle frame comprises first and second u-shaped portions attached to the mounting element and the load cell, wherein the first cradle arm is positioned within the first u-shaped portion and attached to the first u-shaped portion at first and second pivot points, and further wherein the second cradle arm is positioned within the second u-shaped portion and attached to the second u-shaped portion at first and second pivot points.

6. The apparatus of claim 5, wherein the first and second u-shaped portions are slidably attached to the cradle frame such that a distance D between the first and second u-shaped portions can be adjusted.

7. The apparatus of claim 6, wherein the first and second u-shaped portions can be fixed in place.

8. The apparatus of claim 1, wherein the cradle frame is pivotably attached to the base via the mounting element such that it is rotatable about a fourth axis that is substantially parallel to the base and substantially orthogonal to the first and second axes.

9. The apparatus of claim 1, wherein the cradle further comprises first and second locking mechanisms, wherein the first locking mechanism is configured to fix the first cradle arm in place such that it cannot rotate about the first axis, and the second locking mechanism is configured to fix the second cradle arm in place such that it cannot rotate about the second axis.

10. The apparatus of claim 1, wherein the specimen comprises an ear of corn.

11. The apparatus of claim 1, wherein the actuator is manually operated.

12. The apparatus of claim 1, wherein the actuator is coupled to a drive mechanism.

13. The apparatus of claim 1, wherein the specimen receiving portion of each of the first and second cradle arms comprises a curved shape.

14. A system, comprising:
a base;
a cradle, the cradle comprising:
a cradle frame attached to the base via a mounting element; and
first and second cradle arms each rotatably attached to the cradle frame,
wherein each of the first and second cradle arms comprises a specimen receiving portion that is configured to hold a specimen in place, and wherein the first cradle arm is rotatable about a first axis and the second cradle arm is rotatable about a second axis that is substantially parallel to the first axis;
an actuator configured to provide a force F to a central portion of the specimen in a direction substantially orthogonal to the first and second axes and the base;
a load cell positioned between the cradle frame and the base, wherein the load cell is configured to measure F; and
a controller coupled to the load cell, wherein the controller is configured to determine a flexural strength value of the specimen based on a maximum force F_{M} applied to the central portion of the specimen by the actuator at which the specimen yields.

15. The system of claim 14, wherein the actuator comprises a lever rotatably attached to the cradle frame, wherein the lever is rotatable about a third axis that is substantially orthogonal to the first and second axes, and further wherein the lever rotatably moves between the first and second cradle arms in a space between the two arms.

16. A method, comprising:
placing a specimen in an apparatus, wherein the apparatus comprises:
a base;
a cradle, the cradle comprising:
a cradle frame attached to the base via a mounting element; and
first and second cradle arms each rotatably attached to the cradle
frame, wherein each of the first and second cradle arms comprises a specimen receiving portion that is configured to hold a specimen in place, and wherein the first cradle arm is rotatable about a first axis and the second cradle arm is rotatable about a second axis that is substantially parallel to the first axis;
an actuator configured to provide a force F to a central portion of the specimen in a direction substantially orthogonal to the first and second axes and the base; and
a load cell positioned between the cradle frame and the base, wherein the load cell is configured to measure F;
applying force F to a central portion of the specimen in a direction substantially orthogonal to the first and second axes and the base, thereby causing the first and second cradle arms to rotate about the first and second axes respectively in a direction away from the cradle frame; and
measuring a flexural strength value of the specimen.

17. The method of claim 16, wherein the specimen comprises an ear of corn.

18. The method of claim 16, wherein measuring the flexural strength value comprises measuring a maximum force F_{M} applied to the central portion of the specimen.

19. The method of claim 18, wherein measuring the flexural strength value further comprises measuring a distance D between the first and second u-shaped portions.

20. The method of claim 16, further comprising adjusting a distance D between the first and second u-shaped portions prior to applying force F to the central portion of the specimen.
